(19) United States
(12) Patent Application Publication
(10) Pub. No.: US 2012/0326630 A1
(43) Pub. Date: Dec. 27, 2012

(54) DRIVER CIRCUIT

(76) Inventor: MYUNG-HO SEO, Gwaseong-si (KR)

(21) Appl. No.: 13/482,545

(22) Filed: May 29, 2012

(30) Foreign Application Priority Data
Jun. 22, 2011 (KR) 10-2011-0060798

(51) Int. Cl. H05B 37/02

(52) U.S. Cl. 315/297

(57) ABSTRACT

A light-emitting diode (LED) driver circuit configured to generate a constant driving voltage irrespective of a variation in a load current. The LED driver circuit, which may generate an LED driving voltage, may include a booster configured to generate the LED driving voltage in response to a control signal, a voltage detector configured to divide an output voltage of the booster and output a detection voltage, and a booster controller configured to generate the control signal. The booster controller may select one of a pulse-width modulation signal and a fixed logic-level signal as the control signal in response to an LED current signal and the detection voltage and output a selected signal.

### CROSS-REFERENCE TO RELATED APPLICATIONS

This application claims priority to Korean Patent Application No. 10-2011-0060798, filed on Jun. 22, 2011, in the Korean Intellectual Property Office, the disclosure of which is incorporated by reference herein in its entirety.

### TECHNICAL FIELD

Embodiments of the inventive concept relates to driver circuits, and more particularly to light-emitting diode (LED) driver circuits configured to generate a constant driving voltage irrespective of a variation in a load current during the drive of an LED.

### DISCUSSION OF THE RELATED ART

Recent LCD devices have adopted backlight units (BLUs) using LEDs as light sources instead of cold cathode fluorescent lamps (CCFLs). An LED driver circuit with low load regulation outputs a constant voltage irrespective of a variation in a load current during the driving of the LEDs. When the ripple of an output voltage relative to a load current exceeds a predetermined value while the LEDs are driven, the slew rate of an LED current may be affected, thereby degrading the brightness of the LEDs. Also, audible noise may occur according to the magnitude of the ripple of the output voltage. Accordingly, a need exists for an LED driver circuit that can generate a constant output voltage irrespective of a variation in a load current

### SUMMARY

Embodiments of the inventive concept provide a light-emitting diode (LED) driver circuit configured to generate an LED driving voltage, which may reduce the ripple of an output voltage irrespective of a variation in a load current during the driving of an LED.

According to an embodiment of the inventive concept, there is provided an LED driver circuit configured to generate an LED driving voltage. The circuit includes a booster configured to generate the LED driving voltage in response to a control signal, a voltage detector configured to divide an output voltage of the booster and output a detection voltage, and a booster controller configured to generate the control signal. The booster controller selects one of a pulse-width modulation signal and a fixed logic level signal in response to an LED current signal and the detection voltage as the control signal and output the control signal.

The LED current signal is a pulse signal configured to control on/off operations of a switch configured to control supply of current to an LED array comprising a plurality of LEDs.

The booster controller outputs the fixed logic level signal when the LED current signal has a logic level to prevent flow of current to the LED array and the detection voltage has a reference voltage or higher.

In response to the LED driving signal, the booster controller selects one of the pulse-width modulation signal and the fixed logic level signal and outputs the selected signal in response to the LED current signal and the detection voltage when the LED driving signal has a second logic level, and outputs the pulse-width modulation signal when the LED driving signal has a first logic level.

The booster controller includes an error amplifier configured to compare the detection voltage with a reference voltage and output a voltage difference signal corresponding to a difference between the reference voltage and the detection voltage, a pulse-width modulation circuit configured to receive a comparison voltage corresponding to the voltage difference signal as an input signal, compare the comparison voltage with a predetermined saw-tooth wave voltage, output a first logic level when the comparison voltage is lower than the predetermined saw-tooth wave voltage, output a second logic level when the comparison voltage is higher than the predetermined saw-tooth wave voltage, and generate the pulse-width modulation signal, a ripple reduction circuit configured to output a first logic level signal or a second logic level signal in response to the LED current signal and the detection voltage, and a control signal selector configured to select the pulse-width modulation signal or the fixed logic level signal as the control signal output by the booster controller in response to an output signal of the ripple reduction circuit.

The ripple reduction circuit outputs the first logic level signal when the LED current signal has a logic level to prevent the flow of current to the LED array and the detection voltage is higher than the reference voltage.

The control signal selector selects the pulse-width modulation signal as the control signal output by the booster controller when the ripple reduction circuit outputs the second logic level signal.

The control signal selector selects the fixed logic level signal as the control signal output by the booster controller when the ripple reduction circuit outputs the first logic level signal.

According to an embodiment of the inventive concept, there is provided an LED driver circuit configured to generate an LED driving voltage. The circuit includes a booster configured to generate an LED driving voltage in response to a control signal, a voltage detector configured to divide an output voltage of the booster and output a detection voltage, an error amplifier configured to compare the detection voltage with a reference voltage and output a voltage difference signal corresponding to a difference between the reference voltage and the detection voltage, a pulse-width modulation circuit configured to receive a comparison voltage corresponding to the voltage difference signal as an input voltage, compare the comparison voltage with a predetermined saw-toothed wave voltage, output a first logic level signal when the comparison voltage is lower than the predetermined saw-toothed wave voltage, output a second logic level signal when the comparison voltage is higher than the predetermined saw-toothed wave voltage, and generate a pulse-width modulation signal, a ripple reduction circuit configured to output the first logic level signal or the second logic level signal in response to an LED driving signal, an LED current signal, and the detection voltage, a switch connected between an output terminal of the error amplifier and an input terminal of the pulse-width modulation circuit and configured to be turned on and off in response to the LED driving signal and the LED current signal, and a control signal selector configured to output the pulse-width modulation signal or a fixed logic-level signal as a control signal in response to an output signal of the ripple reduction circuit.

The LED driving signal is a signal required to generate the LED current signal, and the LED current signal is a pulse signal for controlling on/off operations of the switch configured to control supply of current to an LED array including a plurality of LEDs.

The ripple reduction circuit outputs a first logic-level signal when the LED driving signal has a logic level to generate the LED current signal, the LED current signal has a logic level to prevent flow of current to the LED array, and the detection voltage is a reference voltage or higher.

The control signal selector selects the pulse-width modulation signal as the control signal when the ripple reduction circuit outputs the second logic-level signal, and selects the fixed logic-level signal as the control signal when the ripple reduction circuit outputs the first logic-level signal.

The switch remains turned on irrespective of the LED current signal when the LED driving signal has a logic level not to generate the LED current signal.

When the LED driving signal has a logic level to generate the LED current signal, the switch is turned on when the LED current signal has a logic level to allow the flow of current to the LED array, and is turned off when the LED current signal has a logic level to prevent the flow of current to the LED array.

The switch includes a transmission gate.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram of a light-emitting diode (LED) backlight unit (BLU);

FIG. 2 is a circuit diagram of a booster and a voltage detector of the LED BLU of FIG. 1, according to exemplary embodiments of the inventive concept;

FIG. 3 is a circuit diagram of a booster controller of the LED BLU of FIG. 1, according to an exemplary embodiment of the inventive concept;

FIG. 4 is a timing diagram showing the generation of a pulse-width modulation signal;

FIG. 5 is a circuit diagram of the ripple reduction circuit 13 of FIG. 3, according to an exemplary embodiment of the inventive concept;

FIG. 6 is a circuit diagram of a ripple reduction circuit 13 of FIG. 3, according to an exemplary embodiment of the inventive concept;

FIG. 7 is a circuit diagram of a booster controller according to an exemplary embodiment of the inventive concept; and

FIGS. 8A and 8B are respectively timing diagrams of a conventional circuit and an LED driver circuit according to an exemplary embodiment of the inventive concept.

### DETAILED DESCRIPTION OF THE EMBODIMENTS

Hereinafter, the inventive concept will be described in detail by describing exemplary embodiments of the inventive concept with reference to the attached drawings. Like reference numerals in the drawings may denote like or similar elements throughout the specification and the drawings.

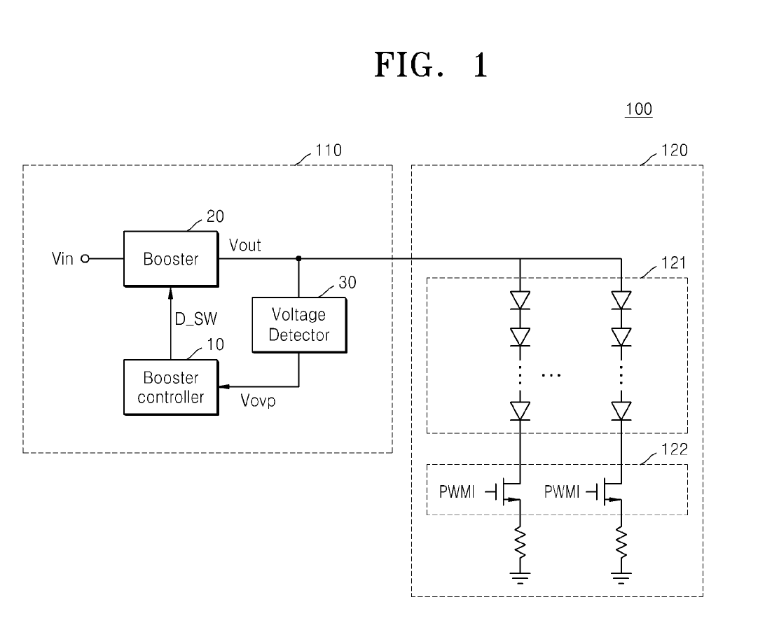

FIG. 1 is a block diagram of a light-emitting diode (LED) backlight unit (BLU) 100.

Referring to FIG. 1, the LED BLU includes an LED driver circuit 110 and an LED array unit 120.

The LED array unit 120 receives an output voltage Vout of a booster 20 and emits or stops emitting light in response to an LED current signal PWMI. The LED array unit 120 includes an LED array 121 including a plurality of LEDs and a switch 122 connected to terminals of the LED array 121 and configured to be turned on and off. The brightness of the LEDs is controlled by turning on and off the switch 122. When the switch 122 is turned on in response to an LED current signal PWMI, a current of about several tens of milliampere (mA) is supplied to the LED array 121 so that the LEDs emit light. When the switch 122 is turned off in response to the LED current signal PWMI, no current is supplied to the LED array 120 so that light emission stops. The LED current signal PWMI is a pulse signal having a frequency of several hundreds of hertz (Hz) to several tens of kilohertz (KHz), which cannot be recognized by human eyes. The LED current signal PWMI controls the LEDs to emit or stop emitting light and regulates the brightness of the LEDs.

According to an embodiment, the LED array 121 includes LEDs, organic LEDs (OLEDs), flexible OLEDs (FOLEDs), phosphorescent OLEDs (PhOLEDs), polymer LEDs (PLEDs), passive-matrix OLEDs (PMOLEDs), polymer OLEDs (POLEDs), resonant-color OLEDs (RCOLEDs), small-molecule OLEDs (SmOLEDs), stacked OLED (SOLEDs), transparent OLEDs (TOLEDs), or neon organic iodine diode (NOIDs).

The LED driver circuit 110 includes a booster controller 10, a booster 20, and a voltage detector 30. The booster controller 10 generates a control signal D_SW to control the boosting of the booster 20 in response to a detection voltage Vovp applied from the voltage detector 30. The booster 20 boosts an input voltage Vin in response to the control signal D_SW and generates an output voltage Vout to drive the LED array 121. The voltage detector 30 divides the output voltage Vout of the booster 20 and outputs a detection voltage Vovp.

The output voltage Vout of the booster 20 may cause a ripple as a load current varies by turning on or off the switch 122 of the LED array unit 120.

When the ripple of the output voltage Vout reaches a predetermined value or more, the slew rate of current supplied to the LED array 121 may be affected to degrade the brightness of the LEDs. Also, audible noise may occur according to the magnitude of the ripple. The booster controller 10 allows the booster 20 to generate a constant output voltage Vout irrespective of the variation in the load current.

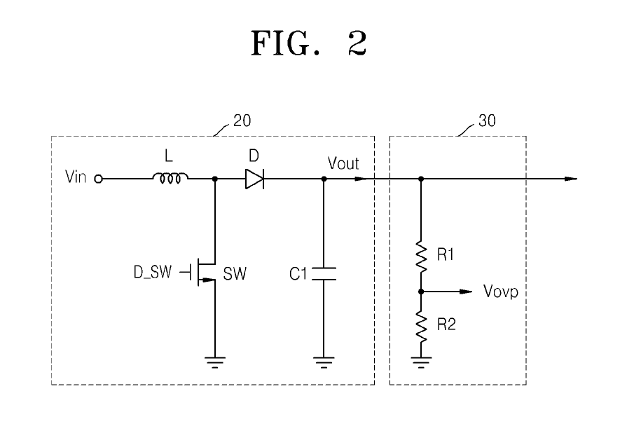

FIG. 2 is a circuit diagram of the booster 20 and the voltage detector 30 of the LED BLU 100 of FIG. 1, according to an exemplary embodiment of the inventive concept.

The booster 20 boosts the input voltage Vin, generates a high direct-current (DC) voltage to drive the LED array 121, and outputs the high DC voltage as an output voltage Vout.

The voltage detector 30 divides the output voltage Vout of the booster 20 using resistors and outputs a detection voltage Vovp.

Specifically, the booster 20 includes a circuit including an inductor L, a diode D, a switch SW, and a capacitor C1 and generates the output voltage Vout by on/off operations of the switch SW. The on/off operations of the switch SW are determined in response to the control signal D_SW of the booster controller 10 of FIG. 1. The booster 20 includes a switch-mode power supply (SMPS) circuit. The SNIPS circuit converts the input voltage Vin into a DC voltage having a desired voltage level by on/off duty control operations of the switch SW. The SMPS circuit converts the input voltage Vin into a DC voltage having a higher or lower voltage level than the input voltage Vin. The booster 20 of FIG. 2 includes an SMPS circuit configured to convert the input voltage Vin into the DC voltage having a higher voltage level than the input voltage Vin.

The operation of the booster 20 is described. When the switch SW is turned on, energy is accumulated in the inductor L in response to the input voltage Vin, and the diode D cuts off the current flow. When the switch SW is turned off, the energy accumulated in the inductor L is accumulated through the diode D to the capacitor C, and as a consequence, the output voltage Vout is generated. For example, the booster 20 leads to a variation in current supplied to the inductor L by the on/off operations of the switch SW so that an electromotive force (EMF) is generated in the inductor L and the EMF induces a high voltage. A voltage gain M of the booster 20 is obtained by Equation 1:

M=Vout/Vin=1/(1−Duty) and Duty=Ton/(Ton+Toff), [Equation 1]

where Ton is the ON time of the switch SW, and Toff is the OFF time of the switch SW.

Although it is illustrated in FIG. 2 that the switch SW of the booster 20 is embodied as an N-type MOSFET, the embodiments of the present inventive concept are not limited thereto. According to an embodiment, the switch SW of the booster 20 is embodied as a different kind of switch. The booster 20 is not limited to the circuit described in connection with FIGS. 1 and 2, and according to an embodiment, may include an SMPS circuit having various configurations.

The voltage detector 30 divides the output voltage Vout of the booster 20 using a first resistor R1 and a second resistor R2 and outputs as a divided voltage the detection voltage Vovp. Specifically, the output voltage Vout of the booster 20 is divided by a ratio of a resistance of the second resistor R2 to a sum of resistances of the first and second resistors R1 and R2 and outputs a divided voltage as the detection voltage Vovp. The detection voltage Vovp is a voltage required to monitor the output voltage Vout and to generate the output voltage Vout of the booster 20 as a desired voltage level. The detection voltage Vovp is applied to the booster controller 10 of FIG. 1 and controls the generation of the control signal D_SW output by the booster controller 10.

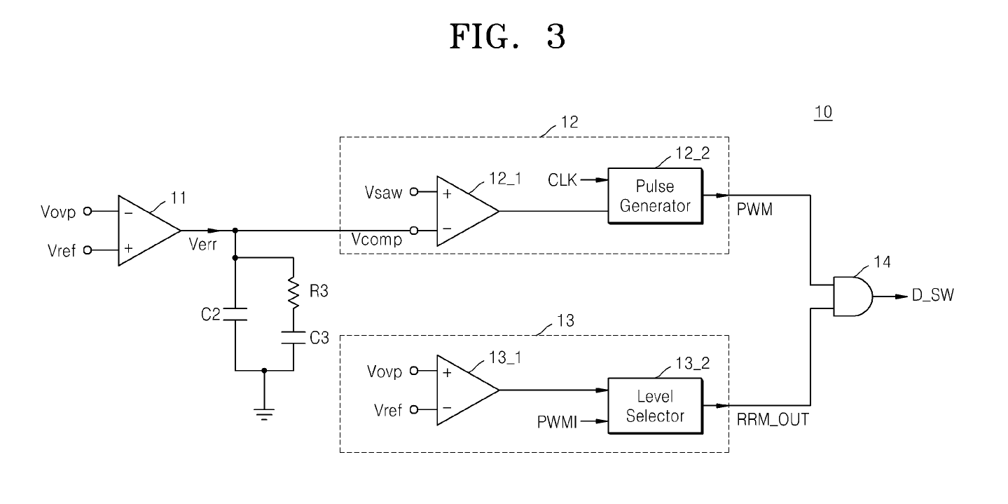

FIG. 3 is a circuit diagram of the booster controller 10 of the LED BLU 100 of FIG. 1, according to an exemplary embodiment of the inventive concept.

Referring to FIG. 3, the booster controller 10 includes an error amplifier 11, a pulse-width modulation circuit 12, a ripple reduction circuit 13, and a control signal selector 14. The booster controller 10 outputs a control signal D_SW for controlling the operation of the booster 20 in response to a detection voltage Vovp of the voltage detector 30.

The error amplifier 11 outputs a voltage difference between a reference voltage Vref and the detection voltage Vovp. The error amplifier 11 has an output terminal connected to a stabilization capacitor C2, and for quick response, a resistor R3 and a capacitor C3 are connected in parallel to the stabilization capacitor C2.

The error amplifier 11 receives the reference voltage Vref through a non-inverting terminal, receives the detection voltage Vovp applied from the voltage detector 30 through an inverting terminal, amplifies a voltage difference between the reference voltage Vref and the detection voltage Vovp, and outputs a voltage difference signal Verr. Since the reference voltage Vref is applied to the non-inverting terminal of the error amplifier 11 and the detection voltage

Vovp is applied to the inverting terminal, when the detection voltage Vovp becomes lower than the reference voltage Vref, the voltage difference signal Verr is output as a positive voltage. When the detection voltage Vovp becomes higher than the reference voltage Vref, the voltage difference signal Verr is output as a negative voltage.

The pulse-width modulation circuit 12 compares a comparison voltage Vcomp corresponding to the voltage difference signal Verr output from the error amplifier 11 with a predetermined saw-tooth wave voltage Vsaw and generates a pulse-width modulation signal PWM.

A comparator 12_1 of the pulse-width modulation circuit 12 receives the saw-tooth wave voltage Vsaw through a lion-inverting terminal, receives the comparison voltage Vcomp through an inverting terminal, compares the saw-tooth wave voltage Vsaw with the comparison voltage Vcomp, and outputs an output signal at a first logic level or second logic level. According to an embodiment, the first logic level is a low level, and the second logic level is a high level. When the comparison voltage Vcomp is lower than a lowest voltage of the saw-tooth wave voltage Vsaw, the comparator 12_1 outputs a second logic-level (or high-level) signal. When the comparison voltage Vcomp is between the lowest voltage and a highest voltage of the saw-tooth wave voltage Vsaw, the comparator 12_1 outputs the first logic-level (or low-level) signal within a section where the comparison voltage Vcomp is higher than the saw-tooth wave voltage Vsaw, and outputs the second logic-level (or high-level) signal within a section where the comparison voltage Vcomp is lower than the saw-tooth wave voltage Vsaw. The comparator 12_1 alternately outputs the first logic-level signal and the second logic-level signal. The output signal of the comparator 12_1 is applied to a pulse generator 12_2 of the pulse-width modulation circuit 12. The pulse generator 12_2 receives the output signal of the comparator 12_1 and a clock signal CLK and generates a pulse-width modulation signal PWM in synchronization with the clock signal CLK. According to an embodiment, the clock signal CLK is a square wave signal having a frequency of about several tens to several hundreds of KHz. When the comparator 12_1 outputs only the second logic-level (or high-level) signal, the pulse generator 12_2 outputs the first logic-level (or low-level) signal. As a consequence, the pulse-width modulation signal PWM may be output not as a pulse signal but as a low-level signal. When the comparator 12_1 alternately outputs the first logic-level signal and the second logic-level signal, the pulse generator 12_2 generates a pulse signal having a frequency of about several tens to several hundreds of KHz in synchronization with the clock signal CLK and outputs the pulse-width modulation signal PWM. The pulse-width modulation signal PWM is output as the control signal D_SW for determining on/off operations of the switch SW of the booster 20 during a boosting operation.

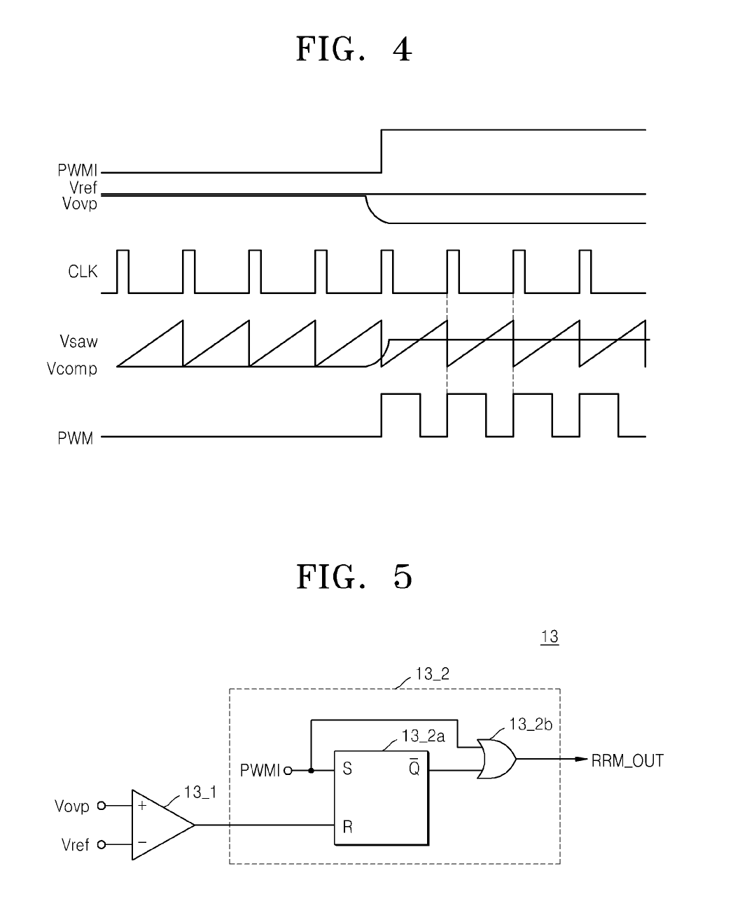

A process of generating the pulse-width modulation signal PWM by the pulse-width modulation circuit 12 is described with reference to FIG. 4, which is a timing diagram showing the generation of the pulse-width modulation signal PWM.

Referring to FIG. 4, the pulse-width modulation signal PWM is output as a pulse signal or a fixed level signal according to a level of the comparison voltage Vcomp.

Specifically, when an LED current control signal PWMI is at a first logic level (or low level), no pulse may occur in the pulse-width modulation signal PWM. When the LED current signal PWMI is at the first logic level (or low level), the switch 122 of the LED array unit 120 remains turned off and no load current is supplied to the LED array 121 so that an output voltage Vout of the booster 20 can remain at a desired voltage level. As a result, since the detection voltage Vovp is equal to the reference voltage Vref, the comparison voltage Vcomp output by the error amplifier iris lower than the lowest voltage of the saw-tooth wave voltage Vsaw, and thus the pulse-width modulation circuit 12 generates not the pulse signal but the first-level (or low-level) signal as the pulse-width modulation signal PWM. The pulse-width modulation circuit 12 outputs not the pulse signal but a fixed logic-level signal (e.g., a low-level signal) as the pulse-width modulation signal PWM so that the booster 20 of FIG. 2 can no longer boost an input voltage.

When the LED current signal PWMI is switched to the second logic level (or high level), current is supplied to the LED array 121 so that the output voltage Vout of the booster 20 can drop to a desired voltage level or lower due to a voltage drop caused by a load current. As a consequence, as the detection voltage Vovp becomes lower than the reference voltage Vref, the comparison voltage Vcomp rises. Thus, the pulse-width modulation circuit 12 of FIG. 3 generates a high-level signal within a section where the comparison voltage Vcomp is higher than the saw-tooth wave voltage Vsaw, and generates a low-level signal within a section where the comparison voltage Vcomp is lower than the saw-tooth wave voltage Vsaw. The pulse-width modulation circuit 12 of FIG. 3 sequentially generates the high-level signal and the low-level signal and outputs a pulse signal corresponding to the sequential signal generating operations as the pulse-width modulation signal PWM. Since the booster 20 of FIG. 2 performs a switching operation in response to the pulse signal generated by a comparison between the saw-tooth wave voltage Vsaw of the booster controller 10 and the comparison voltage Vcomp, the speed of a boosting operation depends on whether or not the comparison voltage Vcomp reaches a level required to generate the pulse signal.

Referring back to FIG. 3, when no load current is supplied to the LED array 121 during the driving of the LEDs (e.g., when the LED current signal PWMI has a first logic level (or low level)) and the output voltage Vout of the booster 20 has a desired voltage level or higher, the ripple reduction circuit 13 outputs a fixed level signal instead of the pulse-width modulation signal PWM as the control signal D_SW output by the booster controller 10 and enables the booster 20 to stop boosting.

According to the process of generating the pulse-width modulation signal PWM described with reference to FIG. 4, when the output voltage Vout reaches a desired voltage level, the comparison voltage Vcomp becomes lower than the saw-tooth wave voltage Vsaw so that no pulse signal is generated. However, when an LED load current varies during the driving of the

LEDs, the output voltage Vout ripples so that the comparison voltage Vcomp cannot rapidly respond to the output voltage Vout. As a consequence, even when the output voltage Vout reaches a desired voltage level, since the comparison voltage Vcomp is higher than the lowest value of the saw-tooth wave voltage Vsaw, the pulse-width modulation signal PWM is generated as the pulse signal. When the pulse-width modulation signal PWM is applied as a control signal of the switch SW of the switch 20 of FIG. 2, the booster 20 keeps operating so that the output voltage Vout reaches a higher voltage level than a desired voltage level. The above-described phenomenon may occur when no current is supplied to the LED array 121 during the driving of the LEDs As a result, when no current is supplied to the LED array 121 during the driving of the LEDs and the output voltage Vout reaches a desired voltage level, the booster controller 10 outputs not the pulse-width modulation signal PWM but a fixed level signal as the control signal

D_SW by an operation of the ripple reduction circuit 13 to stop the operation of the booster 20, thereby reducing the ripple of the output voltage Vout.

The ripple reduction circuit 13 includes a comparator 13_1 and a level selector 13_2. The comparator 13_1 receives the detection voltage Vovp through a non-inverting terminal, receives the reference voltage Vref through an inverting terminal, and outputs a signal corresponding to a difference between the detection voltage Vovp and the reference voltage Vref as a first logic-level (or low-level) signal or a second logic-level (or high-level) signal. The comparator 13_1 outputs the second logic-level (or high-level) signal when the detection voltage Vovp is higher than the reference voltage Vref, and outputs the first logic-level (or low-level) signal when the detection voltage Vovp is lower than the reference voltage Vref.

The level selector 13_2 receives the output signal of the comparator 13_1 and the LED current signal PWMI and outputs a first logic-level signal or a second logic-level signal.

When the LED current signal PWMI is at a second logic level (or high level), the level selector 13_2 outputs the second logic-level signal. When the LED current signal PWMI is at a first logic level (or low level), the level selector 132 outputs a second logic-level (or high-level) signal in response to the first logic-level (or low-level) output signal of the comparator 13_1, and outputs a first logic-level (or low-level) signal in response to the second logic-level (or high-level) output signal of the comparator 13_1.

The ripple reduction circuit 13 outputs the first logic-level (or low-level) signal only when the LED current signal PWMI is the first logic-level (or low-level) signal so that no current is supplied to the LED array 121 of FIG. 1 and the detection voltage Vovp is higher than the reference voltage Vref, and outputs the second logic-level (or high-level) signal in other cases.

The control signal selector 14 receives the pulse-width modulation signal PWM output from the pulse-width modulation circuit 12 and an output signal RRM_OUT of the ripple reduction circuit 13 and outputs the pulse-width modulation signal PWM or the fixed logic-level signal as the control signal D_SW output from the booster controller 10.

FIG. 3 illustrates that the control signal selector 14 is an AND gate. Accordingly, when the ripple reduction circuit 13 outputs a first logic-level (or low-level) signal, the control signal selector 14 selects the first logic-level (or low-level) signal as the control signal D_SW. When the ripple reduction circuit 13 outputs a second logic-level (or high-level) signal, the control signal selector 14 selects the pulse-width modulation signal PWM output from the pulse-width modulation circuit 12 as the control signal D_SW. Although FIG. 3 illustrates that the control signal selector 14 is an AND gate, the control signal selector 14 may be embodied by a different kind of logic gate or another circuit.

The operation of the booster controller 10 of FIG. 3 is described. During the driving of the LEDs, when the LED current signal PWMI is at a second level (or high level) and the detection voltage Vovp is lower than the reference voltage Vref, the error amplifier 11 outputs a difference between the detection voltage Vovp and the reference voltage Vref as a positive voltage. The output voltage of the error amplifier 11 is applied as a comparison voltage Vcomp to the comparator 12_1 of the pulse-width modulation circuit 12 so that the pulse-width modulation circuit 12 can generate the pulse-width modulation signal PWM. The control signal selector 14 receives the pulse-width modulation signal PWM and the output signal RRM_OUT of the ripple reduction circuit 13 and outputs a first logic-level signal or a second logic-level signal as a combination of the pulse-width modulation signal PWM of the pulse-width modulation circuit 12 and the output signal RRM_OUT of the ripple reduction circuit 13. When the control signal selector 14 includes an AND gate and the pulse-width modulation signal PWM is at the second logic level (or high level), the output signal of the ripple reduction circuit 13 is at a second logic level (or high level), so that the control signal selector 14 outputs the same signal as the pulse-width modulation signal PWM. As a result, when the LED current signal PWMI is at a second logic level, the pulse-width modulation signal PWM output from the pulse-width modulation circuit 12 is output as the control signal D_SW.

When the LED current signal PWMI has a first logic level (or low level), the pulse-width modulation circuit 12 compares the comparison voltage Vcomp with the saw-tooth wave voltage Vsaw and generates a pulse-width modulation signal PWM similarly to when the LED current signal PWMI has a second logic level (or high level). When the detection voltage Vovp is lower than the reference voltage Vref, the ripple reduction circuit 13 outputs a second logic-level (high-level) signal in response to the detection voltage Vovp and the reference voltage Vref. As a result, the ripple reduction circuit 13 outputs the pulse-width modulation signal PWM as the control signal D_SW. However, when the detection voltage Vovp is the reference voltage Vref or higher, the ripple reduction circuit 13 outputs a first logic-level (or low-level) signal, and the control signal selector 14 (e.g., AND gate) outputs the first logic-level (or low-level) signal as the control signal D_SW irrespective of the pulse-width modulation signal PWM.

As a consequence, the booster controller 10 of FIG. 3 outputs the pulse-width modulation signal PWM as the control signal D_SW when the LED current signal PWMI is at a second logic level and when the LED current signal PWMI is at a first logic level and the detection voltage Vovp is the reference voltage Vref or lower. However, when the LED current signal PWMI is at a first level (or low level) and the detection voltage Vovp is the reference voltage Vref or higher, for example, when the output voltage Vout reaches a desired voltage level or higher, the booster controller 10 of FIG. 3 outputs not the pulse-width modulation signal PWM but the fixed level signal as the control signal D_SW and stops the operation of the booster 20 of FIG. 2. As a consequence, when no current is supplied to the LED array 121, the output voltage Vout may be prevented from being generated as a higher voltage level than a desired voltage level.

FIG. 5 is a circuit diagram of the ripple reduction circuit 13 of FIG. 3, according to an exemplary embodiment of the inventive concept.

The ripple reduction circuit 13 includes a comparator 13_1 and a level selector 13_2. The comparator 13_1 receives the detection voltage Vovp and the reference voltage Vref, compares the detection voltage Vovp with the reference voltage Vref, outputs a second logic-level (or high-level) signal when the detection voltage Vovp has a higher voltage level than the reference voltage Vref, and outputs a first logic-level (low-level) signal when the detection voltage Vovp has a lower voltage level than the reference voltage Vref.

The level selector 13_2 outputs the first logic-level signal or the second logic-level signal in response to the output signal of the comparator 13_1 and the LED current signal PWMI.

According to an exemplary embodiment of the inventive concept, the level selector 13_2 includes a latch 13_2a and an OR gate 13_2b. Although the latch 13_2a of FIG. 5 is embodied as an NOR-type set-reset (SR) latch, the latch 13_2a of FIG. 5 may be replaced by a different kind of latch or a flip-flop. The latch 13_2a receives the LED current signal PWMI as a set signal S and the output signal of the comparator 13_1 at a front end as a reset signal R, and outputs a result as a combination of the set signal S and the reset signal R. The OR gate 13_2b receives the output signal of the latch 13_2a and the LED current signal PWMI and determines an output signal RRM_OUT of the ripple reduction circuit 13 as a combination of the output signal of the latch 13_2a and the LED current signal PWMI. For example, when the LED current signal PWMI is at a second logic level (or high level), the OR gate 13_2b outputs a second logic-level (high-level) signal when at least one input signal is at a second logic level (or high level). As a consequence, the output signal RRM_OUT of the ripple reduction circuit 13 is at a second logic level (or high level) irrespective of the output signal of the latch 13_2a. When the LED current signal PWMI is at a first logic level (or low level) and the detection voltage Vovp is higher than the reference voltage Vref, the output signal of the latch 13_2a is at the first logic level (low level), and both input signals of the OR gate 13_2b are at the first logic level (or low level). As a consequence, the output signal RRM_OUT of the ripple reduction circuit 13 may become at the first logic level (or low level).

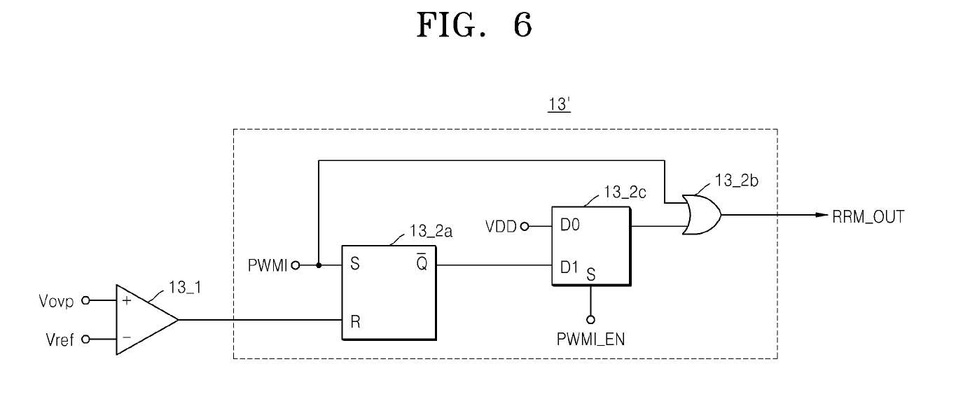

FIG. 6 is a circuit diagram of a ripple reduction circuit 13′ according to an exemplary embodiment of the inventive concept.

The ripple reduction circuit 13′ of FIG. 6 includes a multiplexer 13_2c configured to receive an LED driving signal PWMI_EN as a selection signal, in addition to the level selector 13_2 of the ripple reduction circuit 13 of FIG. 5. The multiplexer 13_2c receives the LED driving signal PWMI_EN as the selection signal, selects one of an output signal of the latch 13_2a and a power supply voltage VDD, and outputs the selected signal. The LED driving signal PWMI_EN, which indicates whether or not the LEDs are driven, controls the generation of the LED current signal PWMI. When the LED driving signal PWMI_EN is at a first logic level (or low level), for example, when the LEDs are not driven, a multiplexer 13_2c outputs a power supply voltage VDD signal (e.g., a second logic-level (or high-level) signal so that an output signal RRM_OUT of the ripple reduction circuit 13′ is at a second level (or high level) irrespective of the LED current signal PWMI and the detection voltage Vovp.

When the LED driving signal is at a second logic level (or high level), for example, when the LEDs are driven, the operation of the ripple reduction circuit 13′ is the same or substantially the same as the operation of the ripple reduction circuit 13 described with reference to FIG. 5. The ripple reduction circuit 13′ according to an embedment controls the multiplexer 13_2c using the LED driving signal PWMI EN and determines the control signal D_SW output from the booster controller 10 using the output signal RRM_OUT of the ripple reduction circuit 13′ only during the drive of the LEDs. When the LED array 120 is not driven, for example, during the generation of a driving voltage prior to the drive of the LEDs, even if no current is supplied to the LEDs and the output voltage Vout of the booster 20 reaches a desired voltage level or higher, the ripple reduction circuit 13′ allows the booster 20 to keep boosting.

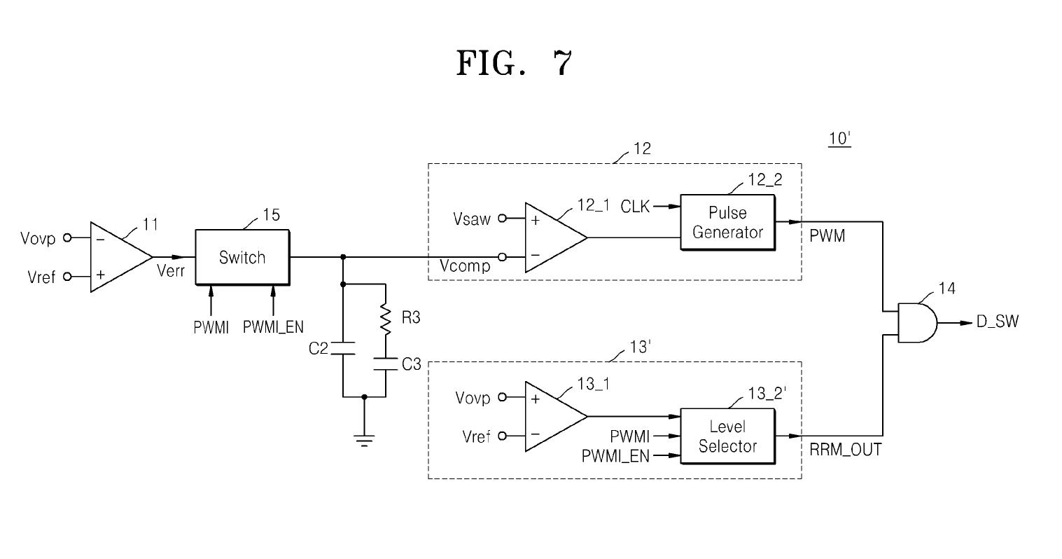

FIG. 7 is a circuit diagram of a booster controller 10′ according to an exemplary embodiment of the inventive concept.

Referring to FIG. 7, the booster controller 10′ includes an error amplifier 11, a pulse-width modulation circuit 12, a ripple reduction circuit 13′, a control signal selector 14, and a switch 15. One terminal of the switch 15 is connected to an output terminal of the error amplifier 11 and another terminal of the switch 15 is connected to an inverting terminal of the comparator 12_1 of the pulse-width modulation circuit 12. The switch 15 operates in response to the LED driving signal PWMI_EN and the LED current signal PWMI. When the LED driving signal PWMI_EN is at a first logic level (or low level), the switch 15 remains turned on so that a voltage difference signal Verr output by the error amplifier 11 can be applied as the comparison voltage Vcomp to the pulse-width modulation circuit 12.

When the LED array 120 of FIG. 1 is not driven, for example, during the generation of a driving voltage prior to the drive of the LEDs, the switch 15 remains turned on irrespective of the LED current signal PWMI. As a consequence, the comparison voltage Vcomp corresponds to the voltage difference signal Verr output from the error amplifier 11 so that the pulse-width modulation circuit 12 can generate the pulse-width modulation signal PWM in response to the output voltage Vout of the booster 10.

The switch 15 turns off when the LED driving signal PWMI_EN is at a second logic level (or high level) and the LED current signal PWMI is at a first logic level (or low level). The switch 15 is turned off within a section where no current is supplied to the LED array 121 during the driving of the LEDs. The comparison voltage Vcomp of the pulse-width modulation circuit 12 does not correspond to the voltage difference signal Verr output from the error amplifier 11 but remains at the same voltage level similarly to before the switch 15 is turned off by the stabilization capacitor C2. Even when the output voltage Vout is elevated due to the boosting by the booster 10 of FIG. 2, the comparison voltage Vcomp does not drop in response to the output voltage Vout. According to an embodiment, since the comparison voltage Vcomp does not drop in response to the output voltage Vout, the pulse-width modulation circuit 12 keeps generating the pulse signal and outputs the pulse-width modulation signal PWM.

However, when the detection voltage Vovp reaches the reference voltage Vref or higher, the booster controller 10′ outputs not the pulse-width modulation signal PWM but a fixed logic-level signal as the control signal D_SW in response to the output signal RRM_OUT of the ripple reduction circuit 13′ and stops the operation of the booster 20. As a result, the output voltage Vout of the booster 20 of FIG. 2 does not rise to higher than a desired voltage level.

Since the comparison voltage Vcomp does not drop in response to the output voltage Vout within a section where the LED current signal PWMI is at the first logic level (or low level), when the LED current signal PWMI is switched from the first logic level (or low level) to the second logic level (or high level) and a load current sharply increases, the booster controller 10′ rapidly generates the pulse-width modulation signal PWM required to normally operate the booster 20 of FIG. 2. For example, when the load current sharply increases and drops the output voltage Vout of the booster 20, the booster controller 10′ generates the pulse-width modulation signal PWM required to normally operate the booster 20 so that the output voltage Vout can be rapidly restored to a desired voltage level. As a consequence, the ripple of the output voltage Vout due to the load current may be reduced.

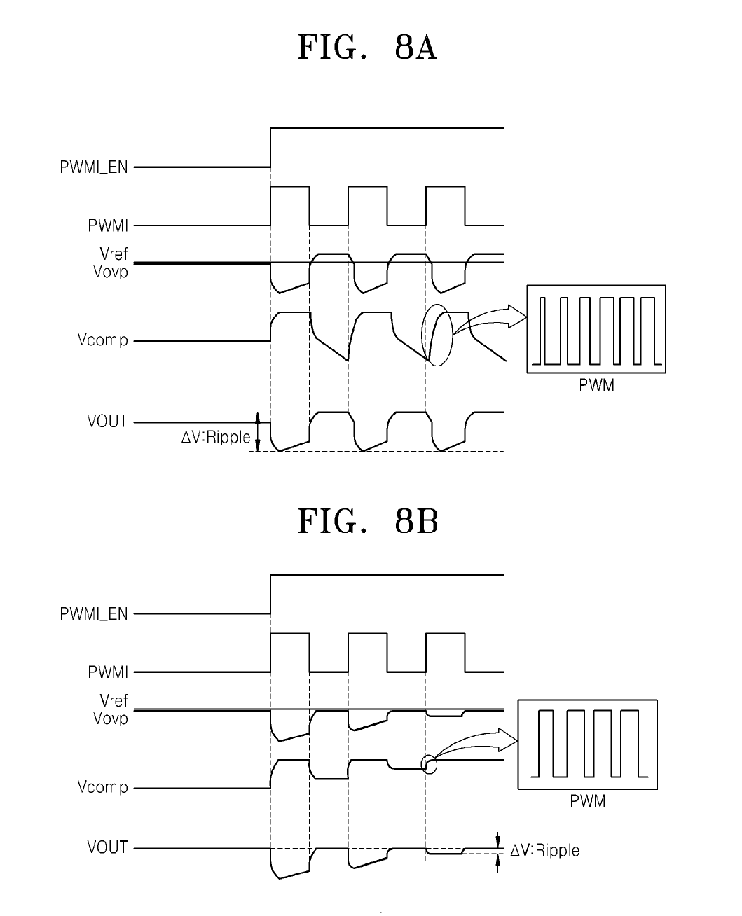

FIGS. 8A and 8B are respectively timing diagrams of a conventional booster controller and an LED driver circuit according to an exemplary embodiment of the inventive concept.

When the LED current signal PWMI is switched during the driving of the LEDs to vary the load current, the output voltage Vout of the booster 20 causes a ripple. To reduce the ripple of the output voltage Vout, a switching operation of the booster 20 rapidly responds to the variation in the load current. In particular, when the load current sharply increases, a pulse-width modulation signal PWM required to normally operate the booster 20 is generated. Since the pulse-width modulation signal PWM is generated in response to the saw-tooth wave voltage Vsaw and the comparison voltage Vcomp as shown in FIG. 4, the speed of a boosting operation depends on whether or not the comparison voltage Vcomp reaches a voltage level required for operations during the variation in the load current.

Referring to FIG. 8A, which is a timing diagram of the conventional booster controller, when the LED current signal PWMI is switched from a second logic level (or high level) to a first logic level (or low level), the comparison voltage Vcomp does not rapidly drop so that the output voltage Vout can become higher than a desired voltage. Since the comparison voltage Vcomp unnecessarily drops in response to the elevated output voltage Vout, when the

LED current signal PWMI is restored to the second logic level, the time taken for the comparison voltage Vcomp to reach a voltage level required for operations increases. Accordingly, the time taken to generate the pulse-width modulation signal PWM required to normally operate the booster 20 increases so that the ripple of the output voltage Voutput increases.

Referring to FIG. 8B, which is a timing diagram of the LED driver circuit according to an embodiment of the inventive concept, while the LED current signal PWMI. is switched from the second logic level (or high level) to the first logic level (or low level), when the output voltage Vout reaches a desired voltage level, the booster controller 10′ outputs not the pulse-width modulation signal PWM but the fixed level signal due to the operation of the ripple reduction circuit 13′ irrespective of the comparison voltage Vcomp and stops the operation of the booster 20. As a result, as shown in FIG. 8B, the output voltage Vout does not rise to higher than a desired voltage level.

When the LED current signal PWMI is at the second logic level (or high level), the switch 15 connected between the output voltage of the error amplifier 11 and the comparison voltage Vcomp of the pulse-width modulation circuit 12 is turned on so that the comparison voltage Vcomp can rise in response to the voltage difference signal Verr output by the error amplifier 11. When the LED current signal PWMI is at the first logic level (or low level), the switch 15 is turned off, and as a consequence, the comparison voltage Vcomp does not drop due to discharge of the output voltage Vout. Only a voltage drop caused by the flow of current to the resistor R3 connected in parallel to the stabilization capacitor C2 occurs. As a result, when the LED current signal PWMI is repetitively switched, the comparison voltage Vcomp is maintained at a constant voltage level. When a load current occurs, for example, when the LED current signal PWMI is at the second logic level (or high level), the booster controller 10′ rapidly generates the pulse-width modulation signal PWM required to normally operate the booster 20. As a result, the booster 20 may normally perform boosting so that the ripple of the output voltage Vout thereof is reduced.

Although the embodiments have been described using the LEDs as light sources, the embodiments of the present inventive concept are not limited thereto. For example, the embodiments of the present inventive concept may also apply to any other lamps or lights.

While the inventive concept has been particularly shown and described with reference to exemplary embodiments thereof, it will be understood that various changes in form and details may be made therein without departing from the spirit and scope of the following claims.

What is claimed is:

1. A light-emitting diode (LED) driver circuit comprising:
a booster configured to generate an LED driving voltage in response to a control signal;
a voltage detector configured to divide an output voltage of the booster and to output a detection voltage; and
a booster controller configured to generate the control signal,
wherein the booster controller is configured to select and output one of a pulse-width modulation signal and a fixed logic level signal as the control signal in response to an LED current signal and the detection voltage.

2. The circuit of claim 1, wherein the LED current signal is a pulse signal configured to control on/off operations of a switch configured to control supply of current to an LED array comprising a plurality of LEDs.

3. The circuit of claim 1, wherein the booster controller is configured to output the fixed logic level signal when the LED current signal has a logic level to prevent the flow of current to the LED array and the detection voltage has a reference voltage or higher.

4. The circuit of claim 1, wherein the booster controller is configured to select and output one of the pulse-width modulation signal and the fixed logic level signal in response to the LED current signal and the detection voltage when an LED driving signal has a second logic level and to output the pulse-width modulation signal when the LED driving signal has a first logic level.

5. The circuit of claim 1, wherein the booster controller comprises:
an error amplifier configured to compare the detection voltage with a reference voltage and to output a voltage difference signal corresponding to a difference between the reference voltage and the detection voltage;
a pulse-width modulation circuit configured to receive a comparison voltage corresponding to the voltage difference signal as an input signal, to compare the comparison voltage with a predetermined saw-tooth wave voltage, to output a first logic level when the comparison voltage is lower than the predetermined saw-tooth wave voltage, to output a second logic level when the comparison voltage is higher than the predetermined saw-tooth wave voltage, and to generate the pulse-width modulation signal;
a ripple reduction circuit configured to output a first logic level signal or a second logic level signal in response to the LED current signal and the detection voltage; and
a control signal selector configured to select the pulse-width modulation signal or the fixed logic level signal as the control signal output by the booster controller in response to an output signal of the ripple reduction circuit.

6. The circuit of claim 5, wherein the ripple reduction circuit is configured to output the first logic level signal when the LED current signal has a logic level to prevent flow of current to the LED array and the detection voltage is higher than the reference voltage.

7. The circuit of claim 5, wherein the control signal selector is configured to select the pulse-width modulation signal as the control signal output by the booster controller when the ripple reduction circuit outputs the second logic level signal.

8. The circuit of claim 5, wherein the control signal selector is configured to select the fixed logic level signal as the control signal output by the booster controller when the ripple reduction circuit outputs the first logic level signal.

9. A light-emitting diode (LED) driver circuit comprising:
a booster configured to generate an LED driving voltage in response to a control signal;
a voltage detector configured to divide an output voltage of the booster and to output a detection voltage;
an error amplifier configured to compare the detection voltage with a reference voltage and to output a voltage difference signal corresponding to a difference between the reference voltage and the detection voltage;
a pulse-width modulation circuit configured to receive a comparison voltage corresponding to the voltage difference signal as an input voltage, to compare the comparison voltage with a predetermined saw-toothed wave voltage, to output a first logic level signal when the comparison voltage is equal to the predetermined saw-toothed wave voltage or lower, to output a second logic level signal when the comparison voltage is higher than the predetermined saw-toothed wave voltage, and to generate a pulse-width modulation signal;
a ripple reduction circuit configured to output the first logic level signal or the second logic level signal in response to an LED driving signal, an LED current signal, and the detection voltage;
a switch connected between an output terminal of the error amplifier and an input terminal of the pulse-width modulation circuit and configured to be turned on and off in response to the LED driving signal and the LED current signal; and
a control signal selector configured to output the pulse-width modulation signal or a fixed logic-level signal as a control signal in response to an output signal of the ripple reduction circuit.

10. The circuit of claim 9, wherein the LED driving signal is a signal for generating the LED current signal, and the LED current signal is a pulse signal for controlling on/off operations of the switch configured to control supply of current to an LED array including a plurality of LEDs.

11. The circuit of claim 9, wherein the ripple reduction circuit is configured to output a first logic-level signal when the LED driving signal has a logic level to generate the LED current signal, the LED current signal has a logic level to prevent the flow of current to the LED array, and the detection voltage is a reference voltage or higher.

12. The circuit of claim 9, wherein the control signal selector is configured to select the pulse-width modulation signal as the control signal when the ripple reduction circuit outputs the second logic-level signal and to select the fixed logic-level signal as the control signal when the ripple reduction circuit outputs the first logic-level signal.

13. The circuit of claim 9, wherein the switch is configured to remain turned on irrespective of the LED current signal when the LED driving signal has a logic level not to generate the LED current signal.

14. The circuit of claim 9, wherein when the LED driving signal has a logic level to generate the LED current signal, the switch is configured to turn on when the LED current signal has a logic level to allow the flow of current to the LED array and to turn off when the LED current signal has a logic level to prevent the flow of current to the LED array.

15. The circuit of claim 9, wherein the switch includes a transmission gate.

16. A lamp driving circuit comprising:
a booster configured to boost an input voltage to an output voltage depending on a control signal;
a voltage detector configured to output a voltage divided from the output voltage as a detection voltage; and
a booster controller configured to output the control signal depending on the detection voltage, a predetermined reference voltage, and a current signal turning on and off a lamp connected to the lamp driving circuit, wherein the control signal includes one of a pulse width modulation (PWM) signal or a fixed level signal.

17. The lamp driving circuit of claim 16, wherein the booster controller is configured to output the PWM signal when the current signal is at a high level.

18. The lamp driving circuit of claim 16, wherein the booster controller is configured to output the PWM signal when the current signal is at a low level and the detection voltage is less than the reference voltage.

19. The lamp driving circuit of claim 16, wherein the booster controller is configured to output the fixed level signal when the current signal is at a low level and the detection voltage is equal to or more than the reference voltage.
